(19) United States
(12) Patent Application Publication
(10) Pub. No.: US 2015/0348215 A1
(43) Pub. Date: Dec. 3, 2015

(54) SYSTEM AND METHOD FOR MULTIPLE JURISDICTION WAGE VALIDATION

(71) Applicant: LCPtracker, Inc., Orange, CA (US)

(72) Inventors: Charles Loren Doll, Fullerton, CA (US); Robbie Dowie, Rancho Santa Margarita, CA (US)

(73) Assignee: LCPTRACKER, INC., Orange, CA (US)

(21) Appl. No.: 14/292,492

(22) Filed: May 30, 2014

(51) Int. Cl. G06Q 40/00; G06Q 30/00

(52) U.S. Cl. CPC G06Q 40/125; G06Q 30/018

(57) ABSTRACT

A prevailing wage validation platform comprising a database, a server, and logic data configured to provide instructions that enable the server to perform the following operations: receiving prevailing wage data, indexed by jurisdiction, location, craft and classification, and storing it in the database; receiving and implementing setup instructions from a first user for the assignment of a plurality of jurisdictions, at least a location and a relevant date to a project; receiving from the first user and implementing validation settings; allowing a second user to enter worker's data; validating entered worker's data according to the validation settings received from the first user; and, allowing certification and submission of entered worker's data.

### BACKGROUND OF THE INVENTION

1. Field of the Invention

The invention relates generally to systems and processes for recording, validating and reporting data, and more particularly to a system and process for recording, validating and reporting prevailing wage data in multiple jurisdictions.

2. Description of the Related Art

Public agencies and construction contractors are often faced with the enormous burden of complying with several overlapping sets of prevailing wage regulations from the local (typically state) government, federal government, and other authorities. These sets of regulations are overlapping, different, and independent of each other and often have contradictory requirements that change over a time period as short as a month. Thus, both, public agencies and construction contractors must repetitively check these requirements every week, to ensure compliance. This is obviously a very time consuming process, and requires the expenditure of significant financial and manpower resources.

Further, because of the differences in regulations, reporting information to all the jurisdictions can for example require the contractor/user to more finely define work breakdown in the payroll process. Also, the contractor submitting the reports and the administrator receiving the reports are both faced with the task of checking the same reported information against the independent rules of the various jurisdictions. This is not only extremely time consuming, but also prone to serious errors. As such, this process is inefficient and ineffective.

While prior art systems allow validation and reporting of prevailing wages one jurisdiction at a time, this is also inefficient as it requires contractor/user to enter the wage data repeatedly for each jurisdiction. Further, the contractor and the administrator are faced with similar checking and error problems as above. In addition, this approach may also be prone to missing to report the payroll data required by some of the jurisdictions, when more than one jurisdiction is associated with a project.

Thus, there is a need for a new and improved system and process that solve the problems outlined above.

The problems and the associated solutions presented in this section could be or could have been pursued, but they are not necessarily approaches that have been previously conceived or pursued. Therefore, unless otherwise indicated, it should not be assumed that any of the approaches presented in this section qualify as prior art merely by virtue of their presence in this section of the application.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment, the system and process disclosed herein provides the ability to automatically and independently test the requirements of each jurisdiction assigned to a project from a single set of data entered as payroll information by a user. By providing a way to check multiple sets of regulations independently and automatically with every data submittal, the time required to check the data for compliance is dramatically reduced and thus the associated risk of being fined for an error is also dramatically reduced.

The ability to apply the rules of multiple jurisdictions to one set of data entered by user and the ability to report the rules and the results to the administrator or user, and providing a way to ensure that worker's prevailing wage data meets the requirements of multiple jurisdictions simultaneously, are additional advantages of the invention.

The above embodiments and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1 illustrates a diagrammatic view of a system for multi jurisdictional wage validation, according to an embodiment.

FIG. 2 is a flow chart depicting a process for multi jurisdictional wage validation, according to an embodiment.

FIGS. 3a-d illustrate user interfaces employable for initial setup of the process for multi jurisdictional wage validation, according to an embodiment.

FIGS. 4a-b illustrate user interfaces configured for multi jurisdictional craft and classification selection, according to an embodiment.

FIGS. 5a-c illustrate user interfaces configured for payroll entries, to support the process for multi jurisdictional wage validation.

FIGS. 6a-b illustrate sample violation notices displayable to user in the process of multi jurisdictional wage validation.

FIG. 6c illustrates a sample user interface giving user access to editing payroll entries, for addressing violation notices.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

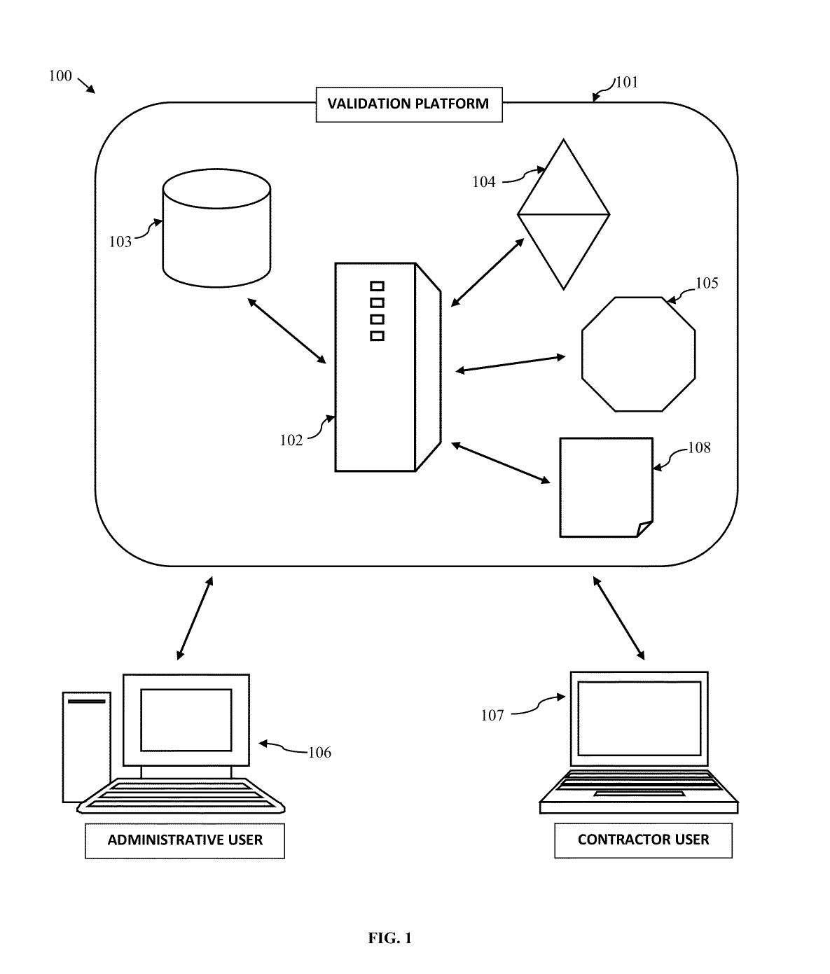

FIG. 1 illustrates a diagrammatic view of a system 100 for multi jurisdictional wage validation, according to an embodiment. As shown, the system 100 may include a validation platform 101, an administrative user computer 106 and a contractor user computer 107. The computers 106 and 107 may be for example personal computers well known in the art, and comprising a processor, a memory, an input device (e.g., a keyboard) and an output device (e.g., a display). The computers 106 and 107 may communicate with the validation platform 101 through a network, such as the Internet.

The validation platform 101, as shown, may include a server 102, a database 103, a validation module 104, a notice module 105 and a certification module 108. These modules are logic modules and thus they may be software modules, hardware modules or a combination thereof configured to perform or to provide instructions to server 102 to perform the functions described below. These modules may be separate modules as depicted, or integrated in any combination thereof. What is important is that the functions of the system 100 described below are properly supported and performed.

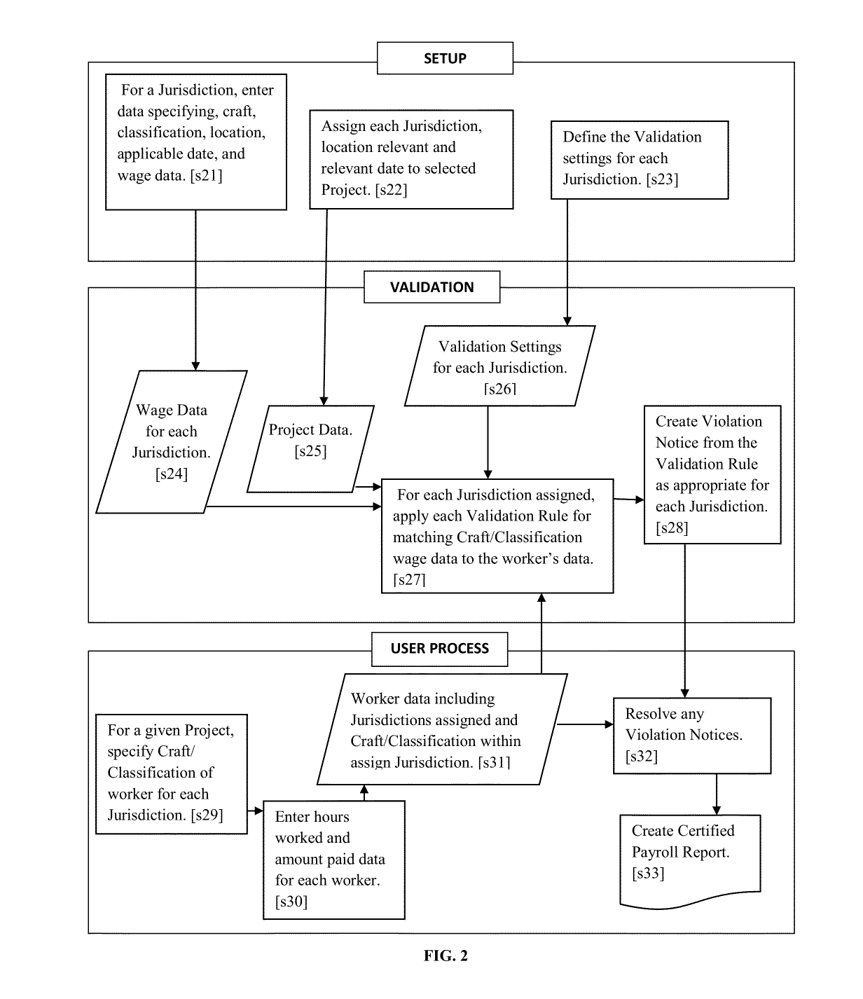

The functions of the system 100 and the interoperability of its components will be readily apparent from the description below, when referring to FIG. 2 and the subsequent figures.

FIG. 2 is a flow chart depicting a process for multi jurisdictional wage validation, according to an embodiment. As shown in FIG. 2, the process includes three categories of steps or activities: setup, user process, and validation.

The Setup Process.

First, typically, the operator of the validation platform 101 and/or the administrative user from her computer 106 (FIG. 1) will have to setup the validation platform 101, as described hereinafter.

For the multi jurisdictional validation platform 101 to function properly, two types of background data need preferably to be established. First (step s21, FIG. 2), prevailing wage data, indexed by jurisdiction, location, construction type, shift, and/or craft/classification is preferably entered and stored in database 103. Data included in this database includes base wages, fringe benefits, overtime rules, and overtime wages. This action may be performed by the operator of the validation platform or by the administrative user. Second (step s22), the assignment of the various jurisdictions, location and relevant date to the project is performed, typically by the administrative user. Any number of jurisdictions can be assigned to a project. For example, federal Department of Labor and California Department of Industrial Relations both publish prevailing wage lists, and the project may fall under both jurisdictions. Thus, both jurisdictions will have to be assigned to the project, because worker's data will have to be reported in compliance with the requirements of both jurisdictions. Once this data is setup, it is available for use in the multi jurisdictional validation process described herein.

In addition, as shown in FIG. 2, the administrative user may be given the option to define (Step s23) validation settings for each jurisdiction, which may be different than the default settings, previously entered by the operator of the validation platform 101. These settings control how the validation module 104 applies the validation rules to the worker's data and how the notice module 105 reports the results to contractor user (107).

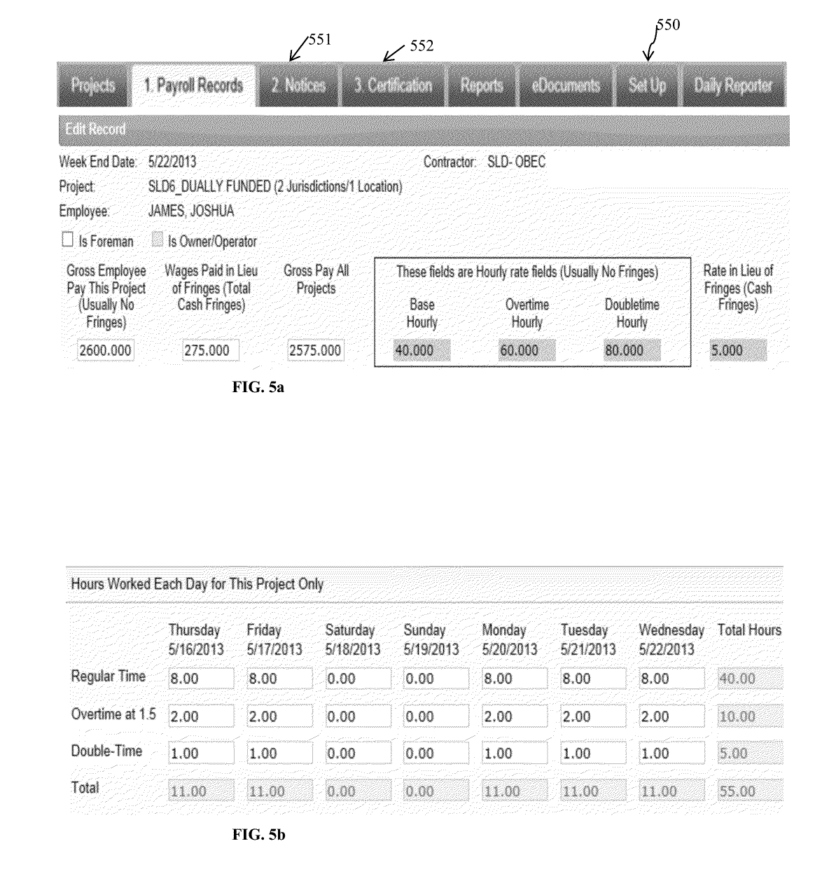

All settings, including the validation settings, may be accessed from a setup tab/button 550 shown in FIG. 5a.

The validation settings feature provides a way for the administrative user to control what checks are made on payroll data, how this information is presented to the contractor users, and how the certification/submittal process is controlled.

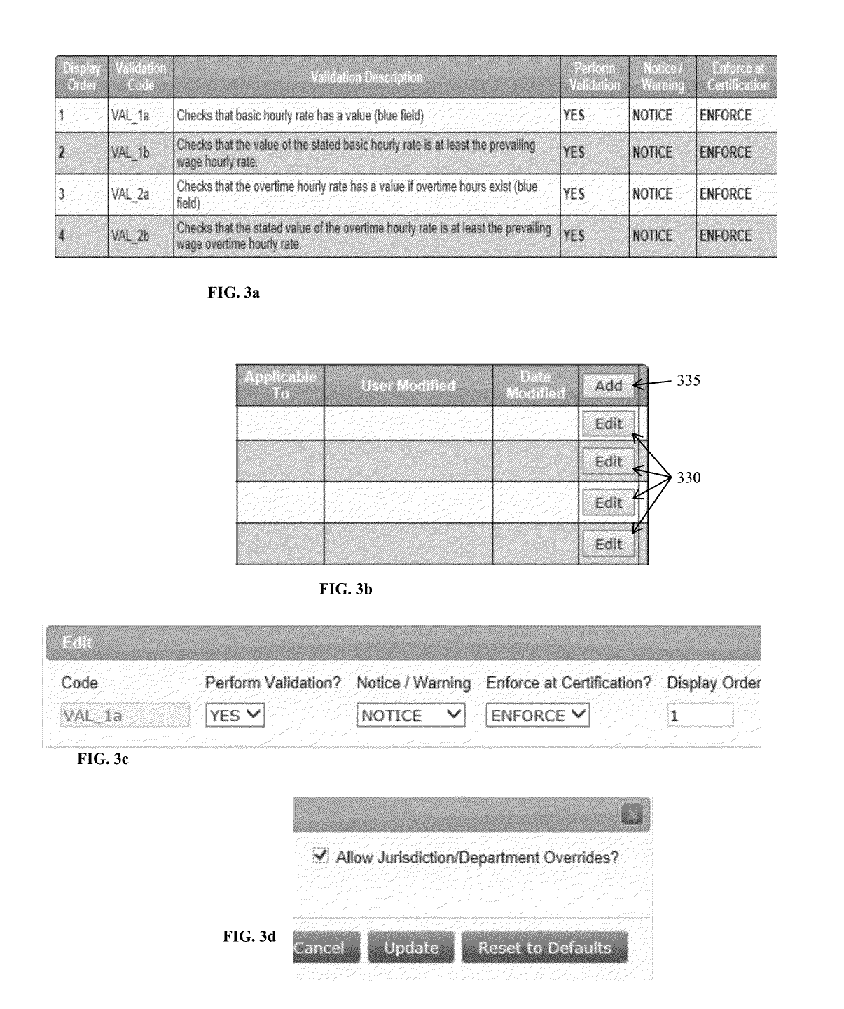

As shown in FIG. 3c, the Administrative user can be provided with the option to control, for example, four aspects of each validation, for each validation rule. An explanation of how these controls work is presented below.

The “Perform Validation” control determines, by selecting Yes or NO, whether or not a particular validation rule (e.g., validation rule coded VAL_{—}1a) will be applied by the validation module 104 to the worker's data.

The “Notice/Warning” control determines, by selecting NOTICE or WARNING, what type of feedback message is sent by the notice module 105 to contractor user when the validation rule is not satisfied. A NOTICE indicates something is wrong based on the validation rules. Contractors will not be able to certify/submit a report if this message is received and is enforced. An example of a NOTICE is the following: “The Basic Hourly Rate paid ($##.##) is less than $##, the wage determination for this craft. VAL_{—}6. Please review the setting of the Voluntary Contributions Included in Gross Emp. Pay check box.”

A WARNING indicates something may be wrong, but insufficient information is available to the program to determine the cause. However, contractors can certify/submit the payroll record under this setting. An example of a WARNING is when straight time is paid for Saturday work which, depending on the craft/classification, may or may not be appropriate.

The “Enforce at Certification?” control offers four options, ENFORCE, ALERT, HIDE, DISCARD and the functionality associated with each option is as follows below.

ENFORCE will force NOTICES to be cleared before certification. ALERT will only warn of the existence of Notices when certifying and will be displayed to the administrative user under a Violations tab (not shown) for example. HIDE will hide the Warning or Notice from the contractor and will not notify them when they enter/certify their payroll, but it will be displayed to the administrative user; thus, in this case, the administrative user is the first person to see the notice/warning generated. DISCARD will only warn the contractor user of the existence of Notices/Warnings when certifying, and will NOT be displayed to the administrative user either.

Lastly, the fourth control, “Display Order,” controls, as suggested, the order in which the validation rules are displayed to the administrator for setting or editing purposes.

As indicated in FIG. 3b, an “Edit” button may be associated with each of the four sample validation rules shown in FIG. 3a, such that the administrative user can edit at any time the four controls described above for each validation rule.

As suggested in FIG. 3d, the validation platform 101 may also be configured to allow jurisdiction or department override. Validation settings are typically done by jurisdiction but the validation platform 101 may be programmed to also allow validation settings by Department. The Department feature is an option that can be used to group validation rules by organizational department, funding source, project managers, etc. If the box is checked as in FIG. 3d, it will allow departments to set the validations as needed for their department. Depending on funding there may be different rules and requirements as to what validations need to be on/off or set as Notices or Warnings.

Similarly, overrides/exceptions per contractor may also be allowed, to be used by the administrative user if wishes to allow a contractor with special circumstances to have a different setting on a certain validation rule check. To create contractor overrides, the administrative user would click the ‘Add’ button 335 (FIG. 3b) to get a popup window (not shown) where the appropriate validation control choices would be made as described above, as well as the choice of the contractor applicable for.

There can be many tens of validations rules. For exemplification purposes sample validation rules are presented below, together with a brief explanation of what each validation does, default control settings, and any recommended settings based on Davis-Bacon Act, unless otherwise noted. As described earlier, an administrative user may wish to set the controls in another manner, depending on the applicable rules, regulations and/or funding sources, for example. In the samples below it is also shown what the contractor user sees as feedback message when they receive the notice. It should be noted that the $##.## represent the prevailing wage amount in the system or the dollar value that contractor user has entered as worker's data; the system will show the actual dollar values in the notices/warnings.

### Validation Rule Example 1

Sample validation rule code: VAL_{—}1a. Description: this rule validates that an hourly rate is entered in the respective field; it checks that the contractor user has actually entered a number in this field. Default/recommended control settings for this rule are Yes/Notice/Enforce. Feedback message: “The stated ‘Hourly rate of pay’ must have a value. VAL_{—}1a.”

### Validation Rule Example 2

Sample validation rule code: VAL_{—}1b. Description: this rule validates that the hourly rate entered is sufficient; it checks that the declared basic hourly rate of pay is greater than or equal to the prevailing wage rate. Default/recommend control settings for this rule are Yes/Notice/Enforce for California (for example) and No for Davis-Bacon Act reporting. Feedback message: The stated basic hourly rate entered in the “Hourly Rate of Pay” field is less than $30.000, the wage determination for this craft. VAL_{—}1b. Correction Tip: Enter in the “Hourly Rate of Pay” field the basic hourly rate for the employee's classification. Check for rounding errors when the difference is less than a penny.”

### Validation Rule Example 3

Sample validation rule code: VAL_{—}26b. Description: Sets Journeyman “No Determination Found” as a Notice or Warning; this validation will check that Journeyman classification chosen by the contractor user for their employee exists in the system. Default—Yes/Warning/Alert, Recommended control setting is Yes/Notice/Enforce. Feedback message: The Journeyman determination needed to validate this record was not found. The validation platform's Support has been notified; the rates will be entered/updated within 48 hours. Sorry for any inconvenience this may have caused you. VAL_{—}26b.”

Contractor User Process

The contractor user in the process of submitting their certified payroll report to the project administrator (administrative user) completes typically the steps described below.

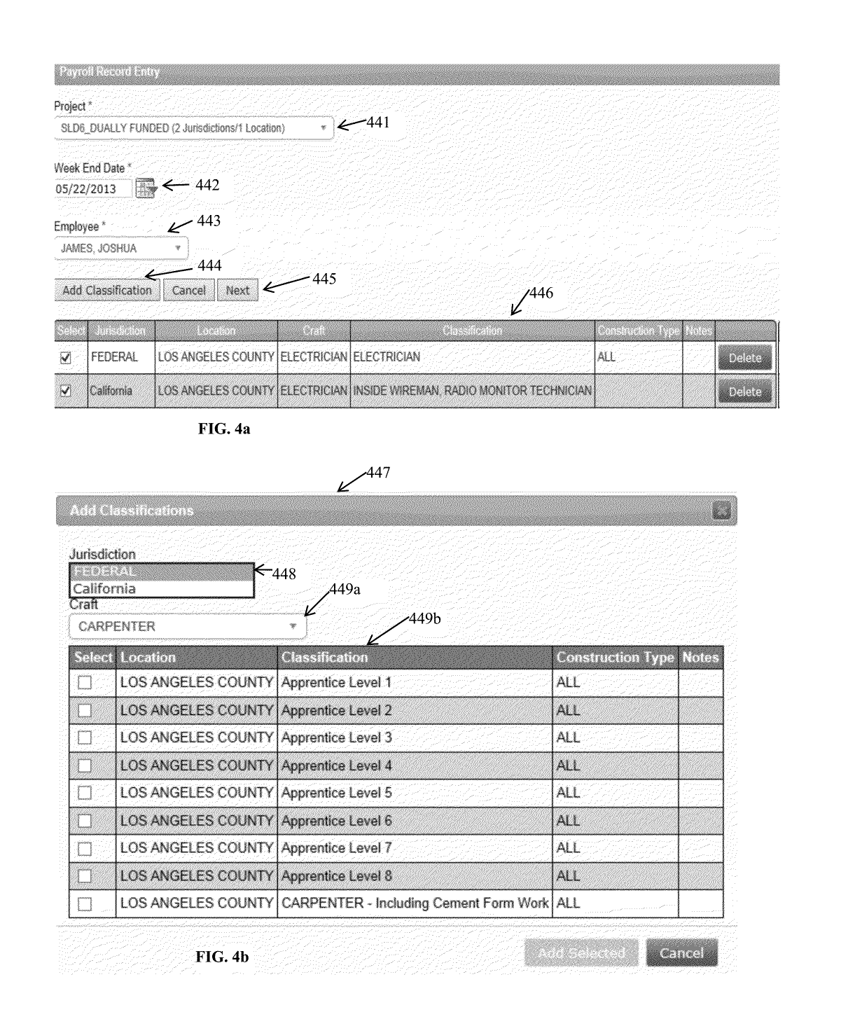

First, in step s29 (FIG. 2), the contractor user selects the project (see 441, FIG. 4a) for which the payroll report is to be submitted, selects a work week end date 442, selects or enters employee name 443 for whom worker's data is to be entered, and selects craft 449a (FIG. 4b) and classification (journey level) 449b associated with each jurisdiction 448 assigned to the project, typically by the administrative user during the setup process described earlier herein.

If, for example, three jurisdictions are assigned to the project, then a valid craft/classification must be selected from the list associate with each jurisdiction. The system may be configured to prevent the contractor user from moving along in this process by pressing a “Next” button 445 for example, without first selecting a valid craft and classification for each jurisdiction assigned to the project. An “Add Classification” tab/button 444 (FIG. 4a) may be provided to contractor user to open a screen 447 where additional selections of craft/classification can be made for the additional jurisdictions associated with the project.

It should be noted in FIG. 4b that classifications 449b are typically listed by location (e.g., county), to account for differences in prevailing wage by location. It should also be noted that the craft/classifications already selected, by jurisdiction and location, may be displayed to contractor user in a corresponding user interface 446, from where the contractor user may proceed to delete and/or edit some, if needed. In any case, as mentioned earlier, the contractor user will preferably be prevented to move forward to entering the hours worked, pay amount, etc, unless a valid craft and classification was selected for this worker (and similarly for all workers), for each jurisdiction assigned to this project. This is a very important control as it ensures that the contractor user, by using the disclosed system and process, will report prevailing wage data to all jurisdictions assigned to the project, and thus avoid for example forgetting some and thus being penalized with fines and/or other sanctions.

It should be noted that the example depicted in FIGS. 4a-b shows only two jurisdictions assigns to this project and only one location. However, it should be understood that a project may cross county lines for example, and thus, more than one location may need to be associated with that project. Further, more than two (the typical state and federal) jurisdictions may be assigned to a project, such as three, four, and so on, the additional/alternative jurisdictions including insurance companies, counties, transportation authorities, and so on. In either case, the system and process disclosed herein allows for proper validation and submission of worker's data.

Next, in step s30, the contractor user enters the hours worked (regular, overtime, double-time) by the selected worker during this week, in the specified crafts and classifications for the selected project and the amount the worker was paid for the hours worked. Additional payroll information (e.g., fringe benefits, vacation information, deductions, etc) may be entered if required. Various accommodating user interfaces may be provided to allow the contractor user to enter these data. Samples of such user interfaces are shown in FIGS. 5a-c.

It should be noted that the validation rules need to be coordinated with the configuration of the user interfaces and the way they collect the payroll data from the contractor user. For example, as shown in FIG. 5c, a separate user interface may be provided to collect data about fringe benefits, such as vacation and holiday pay. Whether or not they are included in the gross pay of the employee must typically be indicated (see 555 in FIG. 5c) in order to ensure proper data validation. The corresponding validation rule must also consider this detail in order to properly verify compliance with the prevailing wage requirements of the jurisdictions assigned to the project.

Next, in step 31, typically upon saving of the entered data by the contractor user, entered worker's data is sent to the validation module 104 (FIG. 1) for validation, which will apply the validation rules (Step s27) and, in coordination with the notice module 105, create and report violation notices to contractor user (Step s28).

Before submitting the worker's data, the notices may be accessed from a “Notices” tab 551 (FIG. 5a). Depending on the enforcement control settings described earlier, the contractor user may, for example after resolving any existing violation notices by correcting data entry, Step s32, create and submit certified payroll reports to the administrative user, Step s33, by pressing for example a “Certification” tab 552 (FIG. 5a). The certification module 108 depicted in FIG. 1 may be configured to generate and submit the certified payroll reports.

Validation Process

As stated earlier validation rule can be set to apply to a particular jurisdiction or not apply. Accordingly, during validation, the validation module 104 will consider these validation settings for each jurisdiction (Step s26) to determine which validation rules to apply to the received worker's data. Wage data for each jurisdiction (Step s24) as well as project data (Step s25) entered during setup are also considered. Further, when the data is entered and/or saved by contractor user, it is sent (Step s31) to the validation checking module 104. In one exemplary embodiment, the first jurisdiction's validation rules (assigned at setup) are applied to the worker's data entered by the contractor user. If a validation rule is not met, then a notice or warning is created and posted to the contractor user or the administrative user, as appropriate (according to the settings entered during setup). After all validation rules are examined, the next jurisdiction's validation rules are applied to the worker's data. This validation process is preferably repeated until all jurisdictions are processed.

In an alternative embodiment, the validation module 104 may be configured to select a validation rule and then apply each jurisdiction to which the validation rule applies according to, for example, the settings entered during the setup process. This process is also preferably repeated until all validation rules are processed.

It should be noted that simultaneous processing of all jurisdictions and/or validation rules may also be implemented, by configuring the validation module 104 as such.

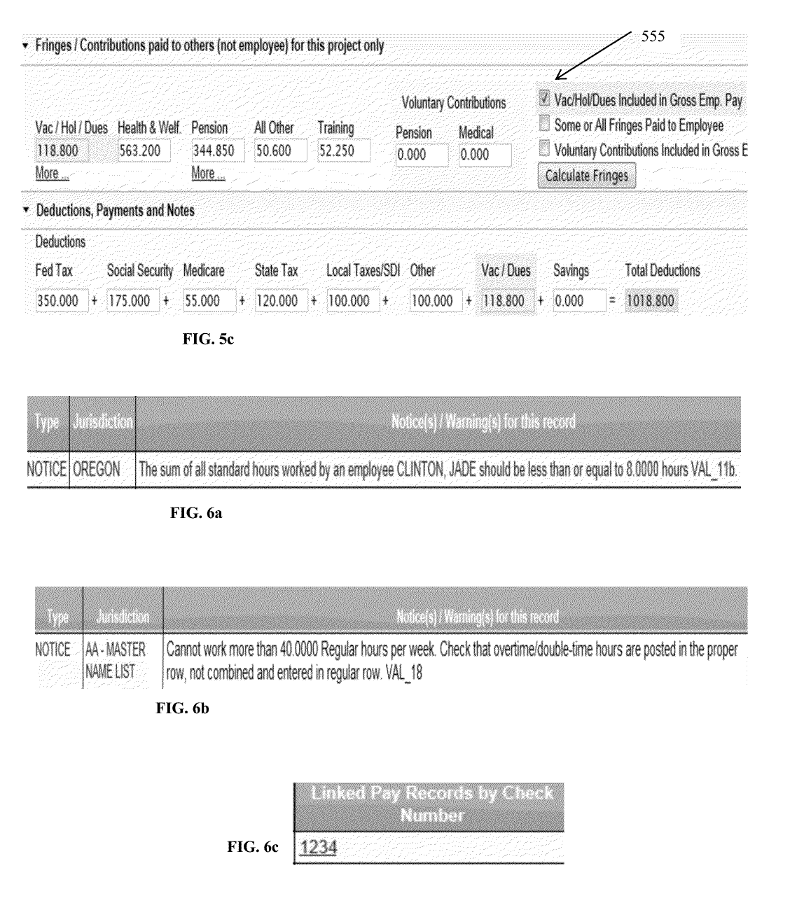

FIGS. 6a-b illustrate sample violation notices displayable to user in the process of multi jurisdictional wage validation. It should be noted that samples user interfaces for displaying such notices is also depicted. FIG. 6c illustrates a sample user interface giving user access to editing payroll entries, for addressing violation notices. As shown in FIG. 6c, a link, which may be for example the check number of the respective employee, may be associated with each violation notice related to that employee, so that the contractor user may easily access the employee's data entry, to be corrected.

Thus, as described above, in an exemplary embodiment the system and process disclosed herein provides the ability to automatically and independently test the requirements of each jurisdiction from a single set of data entered as payroll information. By providing a way to check multiple sets of regulations independently and automatically with every data submittal, the time required to check the data for compliance is dramatically reduced and thus the associated risk of being fined for an error is also dramatically reduced.

In other exemplary embodiments, the system and the processes disclosed provide the ability to apply validation rules of multiple jurisdictions to one set of worker's data entered by contractor user and the ability to report those rules and associated violation notices to the administrative user or contractor user based on setting by administrative user. Further, it is ensured that worker's prevailing wage data meets the requirements of multiple jurisdictions simultaneously, by accurately checking the various jurisdictions' requirements, that the results of the checks are kept preferably separate, by jurisdiction, that the results of the checks are reported to the contractor user and/or the administrative user, and that it provides a process to resolve any problems identified during the checking process, before submission of the worker's data to the administrative user for example.

It may be advantageous to set forth definitions of certain words and phrases used in this patent document.

The term “jurisdiction” means government agency or other organization or authority that defines a set of crafts/classifications for which hours and usually wages must be reported for each worker on the specified project, to ensure compliance with prevailing wage regulations and laws, such as Davis-Bacon Act. Examples of jurisdictions are: Federal Government's Department of Labor, California Department of Industrial Relations, Insurance Industry Workers Compensation Code system and Owner Controlled Insurance Program (OCIP).

The term “location” means a geographical area (e.g., a county) to which a particular wage data applies.

The terms “craft” and “classification” means a set and a level, respectively, of work skills defined by the jurisdiction; for example, electrician/inside wireman.

The term “construction type” means the type of skills needed for style of construction; examples are “commercial”, “residential”, “highway”, and “heavy”.

The phrase “wage data” means a set of data for a given geographical area (typically a county), and as of a defined date, defining what a person working in a given craft/classification will be paid. This is also known as the “prevailing wage”.

The phrase “relevant date” means the date specified by the jurisdiction that defines what set of wage data will be used. For example, the relevant date may be the signing date of the contract for the project.

The term “project” means a set of work defined by the contracting organization for which wage data must be reported (e.g., a bridge construction project).

The phrase “worker's data” means a set of data associated with a specific worker for a specific project, location, craft, classification, shift, and time period that includes but is not limited to hours worked, amount paid including fringe benefits and other data related to the worker and worker's earnings.

The phrase “validation rule” means a set of arithmetic and logical tests that correspond to a requirement imposed by the jurisdiction or by the project contracting organization. This rule may be an arbitrary requirement by the contracting agency, a general law imposed by the legal jurisdictions of the location, or a requirement to pay the relevant wage as defined in wage data to a worker.

The term “validation” means a process which applies a validation rule to submitted worker's data to test if the worker's data meets the validation rule requirements. Failure to meet the requirement results in a violation notice.

The phrase “violation notice” means a notice created for each failure of worker's data to pass a validation rule. Each violation notice specifies what rule was not satisfied and why it was not satisfied.

The phrase “certified payroll report” means a report containing worker's data that is required to be submitted by various jurisdictions and contracting organizations. Each jurisdiction/contracting organization defines the data that must appear on the report. The details of the report change from time to time. Typically, a different certified payroll report is required for each jurisdiction assigned to a project.

The phrase “administrative user” means the person or organization in charge of receiving and verifying compliance of the reported worker's data by a contractor user. For example, the administrative user may be the contracting organization for the project (e.g., a county, a state or federal Department of Transportation, etc.).

The phrase “contractor user” means the person or business entity working on the project, and thus, required to report worker's data for all his/her employees working on the project.

The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

As used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims. Use of ordinal terms such as “first,” “second,” “third,” etc., if any, in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

As used herein and throughout this disclosure, the term “computer” and derivations thereof refers to any electronic device capable of communicating across a network, such as the Internet or a mobile network. A computer may have a processor, a memory, an input, and an output, and also a transceiver. Examples of such devices include portable computers, desktops, smart phones, cellular telephones, personal digital assistants (PDAs), etc. The memory stores applications, software, or logic. Examples of device memories that may comprise logic include RAM (random access memory), flash memories, ROMS (read-only memories), EPROMS (erasable programmable read-only memories), and EEPROMS (electrically erasable programmable read-only memories). Examples of processors are computer processors (processing units), microprocessors, digital signal processors, controllers and microcontrollers, etc. A transceiver includes but is not limited to cellular, GPRS, Bluetooth, and Wi-Fi transceivers.

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network. A network typically includes a plurality of elements such as servers that host logic for performing tasks on the network. Servers may be placed at several logical points on the network. Servers may further be in communication with databases and can enable electronic devices to access the contents of a database.

Throughout this description, the embodiments and examples shown should be considered as exemplars, rather than limitations on the apparatus and procedures disclosed or claimed. Although many of the examples involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the described methods. Acts, elements and features discussed only in connection with one embodiment are not intended to be excluded from a similar role in other embodiments.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, an application, etc.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the invention. Therefore, the scope of this application is intended to cover alternate embodiments and/or equivalent variations of the specific embodiments illustrated and/or described herein. Hence, the scope of the invention is defined by the accompanying claims and their equivalents. Furthermore, each and every claim is incorporated as further disclosure into the specification and the claims are embodiment(s) of the invention.

What is claimed is:

1. A prevailing wage validation platform comprising a database, a server comprising a processor and a memory, the server being in communication with the database, and logic data comprising a validation module, a notice module and a certification module, the logic data being configured to provide instructions that enable the server to perform the following operations:
receiving prevailing wage data, indexed by jurisdiction, location, craft and classification, and storing it in the database;
receiving and implementing setup instructions from a first user for the assignment of a plurality of jurisdictions, at least a location and a relevant date to a project;
receiving from the first user and implementing validation settings that control which validation rules from a set of validation rules will be applied to entered worker's data, for each applied validation rule, whether or not and what type of feedback is received by a second user who entered the worker's data, and how each applied validation rule is enforced;
allowing the second user to select the project, to select a work week end date, to select or enter the name of a worker who worked on the project and whose worker's data is to be entered, and to select a valid craft and classification of the worker, for each of the plurality of jurisdictions assigned to the project;
preventing the second user from proceeding without selecting a valid craft and classification of the worker, for each of the plurality of jurisdictions assigned to the project;
allowing the second user to enter worker's data;
validating entered worker's data according to the validation settings received from the first user;
creating and reporting feedback to second user if permitted by the validation settings received from the first user; and,
allowing certification and submission of entered worker's data by the second user after successful enforcement of each applied validation rule according to the validation settings received from the first user.

2. The prevailing wage validation platform of claim 1, wherein the prevailing wage data comprises base wages, fringe benefits, overtime rules, and overtime wages.

3. The prevailing wage validation platform of claim 1, wherein the setup instructions include instructions to assign four jurisdictions and two locations to the project.

4. The prevailing wage validation platform of claim 1, wherein the first user is a person commissioned to verify compliance of the entered worker's data, and wherein the second user is a contractor required to report worker's data for all of contractor's employees working on the project.

5. The prevailing wage validation platform of claim 1, wherein the feedback is a violation notice comprising information about which validation rule was not complied with and information about how to clear the entered worker's data for compliance, and wherein an enforcement option is to not allow the worker's data to be submitted without making the worker's data compliant.

6. The prevailing wage validation platform of claim 4, wherein an enforcement option is to hide the feedback from the contractor and to display it only to the person commissioned to verify compliance.

7. The prevailing wage validation platform of claim 1, wherein a validation rule is a set of arithmetic and logical tests that correspond to a requirement imposed by one of the plurality of jurisdictions.

8. The prevailing wage validation platform of claim 4, wherein the server is further enabled to receive and implement overriding instructions from the person commissioned to verify compliance, such that to allow different validation settings to be applied to a contractor with special circumstances.

9. The prevailing wage validation platform of claim 1, wherein the worker's data comprises gross employee pay, base hourly pay, overtime pay, double time pay, regular time, overtime and double time worked, deductions and fringe benefits information.

10. The prevailing wage validation platform of claim 1, further comprising allowing review of the submitted worker's data by the first user.

11. A method for prevailing wage validation operable on a computer platform comprising a database, a server comprising a processor and a memory, the server being in communication with the database, and logic data being configured to provide instructions to the server, the method comprising the steps of:
receiving prevailing wage data, indexed by jurisdiction, location, craft and classification, and storing it in the database;
receiving and implementing setup instructions from a computer of a first user for the assignment of a plurality of jurisdictions, at least a location and a relevant date to a project;
receiving from the computer of the first user and implementing validation settings that control which validation rules from a set of validation rules will be applied to entered worker's data, for each applied validation rule, whether or not and what type of feedback is received by a second user who entered the worker's data, and how each applied validation rule is enforced;
allowing the second user to select the project, to select a work week end date, to select or enter the name of a worker who worked on the project and whose worker's data is to be entered, and to select a valid craft and classification of the worker, for each of the plurality of jurisdictions assigned to the project;
preventing the second user from proceeding without selecting a valid craft and classification of the worker, for each of the plurality of jurisdictions assigned to the project;
allowing the second user to enter worker's data;
validating entered worker's data according to the validation settings received from the first user;
creating and reporting feedback to second user if permitted by the validation settings received from the first user;
allowing certification and submission of entered worker's data by the second user after successful enforcement of each applied validation rule according to the validation settings received from the first user; and
allowing review of the submitted worker's data by the first user.

12. The method for prevailing wage validation of claim 11, wherein the prevailing wage data comprises base wages, fringe benefits, overtime rules, and overtime wages.

13. The method for prevailing wage validation of claim 11, wherein the setup instructions include instructions to assign three jurisdictions and one location to the project.

14. The method for prevailing wage validation of claim 11, wherein the first user is a person commissioned to verify compliance of the entered worker's data, and wherein the second user is a contractor required to report worker's data for all of contractor's employees working on the project.

15. The method for prevailing wage validation of claim 11, wherein the feedback is a violation notice comprising information about which validation rule was not complied with and information about how to clear the entered worker's data for compliance, and wherein an enforcement option is to not allow the worker's data to be submitted without making the worker's data compliant.

16. The method for prevailing wage validation of claim 14, wherein an enforcement option is to hide the feedback from the contractor and to display it only to the person commissioned to verify compliance.

17. The method for prevailing wage validation of claim 11, wherein a validation rule is a set of arithmetic and logical tests that correspond to a requirement imposed by one of the plurality of jurisdictions.

18. The method for prevailing wage validation of claim 14, further comprising implementing overriding instructions from the person commissioned to verify compliance, such that to allow different validation settings to be applied to a contractor with special circumstances.

19. The method for prevailing wage validation of claim 11, wherein the worker's data comprises gross employee pay, base hourly pay, overtime pay, double time pay, regular time, overtime and double time worked, deductions and fringe benefits information.
